(19) United States
(12) Patent Application Publication
(10) Pub. No.: US 2026/0042241 A1
(43) Pub. Date: Feb. 12, 2026

(54) DRY CUTTING APPARATUS AND CUTTING METHOD FOR WALL OR SLAB

(71) Applicant: EGUN CO., LTD., Gwangju-si (KR)

(72) Inventors: Sung Jun LEE, Gwangju-si (KR); Chae Mun LEE, Seongnam-si (KR)

(21) Appl. No.: 18/873,806

(22) PCT Filed: Jun. 12, 2023
(86) PCT No.: PCT/KR2023/007997

§ 371 Date: Oct. 19, 2025

(30) Foreign Application Priority Data
Jun. 15, 2022 (KR) 10-2022-0072811

(51) Int. Cl. B28D 1/08; B28D 7/02

(52) U.S. Cl. CPC B28D 1/08; B28D 7/02

(57) ABSTRACT

Disclosed is a dry cutting apparatus including a wire saw device configured to rotate a cutting wire installed so as to pass through two holes formed in a structure by drilling, a roller jig mounted to one side of the structure, the roller jig being configured to guide and support the cutting wire, a cover member coupled to one side of the structure, the cover member being configured to cover and seal a cut region, an air gun configured to blow compressed air to the cut region in a direction toward the cover member, and a dust collection device connected to one side of the cover member via a dust collection hose, the dust collection device being configured to collect debris.

This application is a U.S. national stage under 35 USC 371 of PCT application PCT/KR2023/007997 filed Jun. 12, 2023, which claims benefit of priority to Korean Patent Application No. 10-2022-0072811 filed on Jun. 15, 2022, both of which are incorporated by reference.

### TECHNICAL FIELD

The present invention relates to a dry cutting apparatus and cutting method for walls or slabs, and more particularly to an apparatus and method for dry cutting a wall or a slab while collecting dust.

### BACKGROUND ART

In general, a structure composed of concrete and the like may be cut using a cutting apparatus including a diamond wire. A cutting wire configured to cut a concrete structure, rock, or the like is easily contaminated by various foreign substances, such as dust, water, and sludge, during cutting. In order to cleanly cut the concrete structure or the like, it is necessary to remove such foreign substances from the surface of the wire.

However, there is no conventional apparatus for removing debris from the surface of the cutting wire, and it may be difficult to remove debris from the surface of a long wire by the force of a user. Accordingly, there is a need for a wire dust collection system/dust collection apparatus capable of more effectively removing debris, such as dust, from the surface of the diamond wire or the like.

A conventional dust collection system uses a dust collection container, a dust collection cover, a high-powered motor configured to collect dust, and the like in order to collect debris, such as dust, from a cut surface of a structure by sealing the cut surface of the structure. In addition, when the structure is a massive structure such as a nuclear power plant, high-power, large-scale dust collection facilities are customized and used. The large-scale dust collection facilities are expensive and time-consuming to manufacture, which is inefficient.

In addition, the conventional dust collection system is focused only on collecting debris that escapes from the structure by sealing the cut surface of the structure and collecting dust in a dust collection container under the cutting surface, whereby it is not possible to remove debris from the cutting wire. Since not only debris that is thrown off the cut surface of the structure during cutting but also debris on the cutting wire causes significant environmental pollution, it is important to completely remove the debris from the cutting wire. However, such a dust collection System or dust cover has not yet been proposed.

Meanwhile, in the case of dismantling a reinforced concrete building, a structure, such as a column, a beam, a wall, or a slab, may be dismantled by cutting using a wire saw device. In the case of cutting the wall or the slab, a hole is formed in the structure by drilling, and the wire is allowed to pass through the hole and rotated to cut the structure. In a wet cutting method, coolant is applied to the part cut by the wire to prevent scattering of dust and to cool the wire. However, debris mixed with water splashes onto the structure and the cutting apparatus, making it very cumbersome to remove.

In a dry cutting method, no water is used, and air is blown to the cut part to prevent scattering of dust. However, it is very cumbersome and difficult to install a dust cover so as to seal the entirety of the cut part of the structure.

### DISCLOSURE

### Technical Problem

It is an object of the present invention to provide a dry cutting apparatus configured such that a cover member is easily installed only on one side of a structure, such as a wall or a slab, compressed air is blown toward the cover member using an air gun, a wire saw device is operated to easily cut the structure, and debris generated during cutting is collected by a dust collection device.

### Technical Solution

A dry cutting apparatus according to the present invention to accomplish the above object includes a wire saw device configured to rotate a cutting wire installed so as to pass through two holes formed in a structure by drilling, a roller jig mounted to one side of the structure, the roller jig being configured to guide and support the cutting wire, a cover member coupled to one side of the structure, the cover member being configured to cover and seal a cut region, an air gun configured to blow compressed air to the cut region in a direction toward the cover member, and a dust collection device connected to one side of the cover member via a dust collection hose, the dust collection device being configured to collect debris.

The cover member may include a main body plate portion configured in the form of a rectangular plate, a transparent plate portion coupled so as to cover an opening of the main body plate portion, a pair of sidewall portions bent and extending from both sides of the main body plate portion, and a bottom flange portion extending perpendicularly from the pair of sidewall portions so as to be fastened to the structure.

The cover member may further include a pair of side flange portions each bent outward from one end of a corresponding one of the pair of sidewall portions.

The air gun may include a main body portion configured to allow compressed air to flow therein, a handle portion provided on the main body portion, a valve provided at the handle portion, the valve being configured to control air blowing, and a blowing end portion provided at an end of the main body portion such that an air blowing direction can be controlled.

The roller jig may include a base portion fastened to the structure, a support bracket extending upward from the base portion, and a roller mounted in at least one roller shaft hole formed in the support bracket, the roller being configured to guide and support the cutting wire.

The dry cutting apparatus may further include a bar roller jig installed on the side of the structure opposite the side on which the roller jig is installed, the bar roller jig being configured to guide and support the cutting wire.

The bar roller jig may include a base portion fastened to the structure, a pair of support brackets extending upward from the base portion, and a bar roller rotatably mounted between the pair of support brackets, the bar roller being formed in the shape of a long bar in an axial direction, the bar roller being configured to guide and support the cutting wire.

The dry cutting apparatus may further include a packing member having a through-hole configured to allow the cutting wire to pass therethrough, the packing member being inserted into the hole formed in the structure by drilling, the packing member being configured to seal the hole.

In another embodiment of the present invention, the dry cutting apparatus may further include a pulley moving device having one side coupled to an upper surface of a slab and the other side coupled to a roller jig, the pulley moving device being configured to move a pulley configured to support the cutting wire along the cut region.

In an embodiment of the present invention, the structure to be cut may be a slab, the cover member may be coupled to an upper surface of the slab, the wire saw device may be installed on the upper surface of the slab outside the cover member, and the roller jig may include a base portion fastened to the structure, a first support bracket extending upward from the base portion, a second support bracket extending from the middle of the first support bracket so as to be parallel to the base portion, a first roller mounted in at least one roller shaft hole formed in the first support bracket, and a second roller mounted in at least one roller shaft hole formed in the second support bracket.

In an embodiment of the present invention, the structure to be cut may be a slab, the cover member may be coupled to an upper surface of the slab, the wire saw device may be installed under the slab, and the roller jig may include a base portion fastened to the structure, a support bracket extending upward from the base portion, and a roller mounted in at least one roller shaft hole formed in the support bracket, the roller being configured to guide and support the cutting wire.

In an embodiment of the present invention, the structure to be cut may be a slab, the cover member may be coupled to an upper surface of the slab, the wire saw device may be installed on the upper surface of the slab outside the cover member, and the roller jig may include a base portion fastened to the structure, a “┐”-shaped first support bracket extending upward from the base portion, a “└”-shaped second support bracket extending upward from an upper surface of the base portion, a first roller and an auxiliary roller mounted in a plurality of roller shaft holes formed in the first support bracket so as to be spaced apart from each other by a predetermined distance, and a second roller and an anti-slip roller mounted in a plurality of roller shaft holes formed in the base portion and the second support bracket.

In another embodiment of the present invention, the structure to be cut may be a slab, the cover member may be coupled to each of an upper surface and a lower surface of the slab, the wire saw device may be installed on the upper surface of the slab outside the cover member, the dust collection device may be installed under the slab, the roller jig may include a base portion fastened to the structure, a “┐”-shaped first support bracket extending upward from the base portion, a “└”-shaped second support bracket extending upward from an upper surface of the base portion, a first roller and an auxiliary roller mounted in a plurality of roller shaft holes formed in the first support bracket so as to be spaced apart from each other by a predetermined distance, and a second roller and an anti-slip roller mounted in a plurality of roller shaft holes formed in the base portion and the second support bracket, and the dry cutting apparatus may further include a pulley moving device having one side coupled to the upper surface of the slab and the other side coupled to the roller jig, the pulley moving device being configured to move a pulley configured to support the cutting wire along the cut region.

The pulley moving device may include a guide rail fixed between the upper surface of the slab and the roller jig, a rack gear formed on one side of the guide rail, a moving plate slidably mounted to the guide rail, a pulley rotatably mounted to the moving plate, the pulley being configured to support the cutting wire, a pinion gear rotatably mounted to one side of the moving plate, the pinion gear being configured to engage with the rack gear, and a motor configured to rotate the pinion gear.

The pulley moving device may further include a dust collection port coupled to the moving plate, the dust collection port being configured to collect debris from the cut region.

### Advantageous Effects

In a dry cutting apparatus according to the present invention, a cover member is easily installed only on one side of a structure, such as a wall or a slab, compressed air is blown toward the cover member using an air gun, a wire saw device is operated to easily cut the structure, and debris generated during cutting is collected by a dust collection device.

### DESCRIPTION OF DRAWINGS

FIG. 1 is a view showing that a wall is cut using a dry cutting apparatus according to an embodiment of the present invention.

FIG. 2 is a view showing a cover member mounted to one side of a structure.

FIG. 3 is a view showing a structure in which two cover members are connected to each other.

FIG. 4 is a view showing an air gun.

FIG. 5 is a view showing a first roller jig.

FIG. 6 is a view showing a bar roller jig.

FIG. 7 is a view showing a packing member.

FIG. 8 is a view showing that a wall is cut using a dry cutting apparatus according to another embodiment of the present invention.

FIG. 9 is a front view (a) and a left side view (b) showing a pulley moving device.

FIG. 10 is a view showing that a slab is cut using a dry cutting apparatus according to an embodiment of the present invention.

FIG. 11 is a view showing a second roller jig.

FIG. 12 is a view showing that a wire saw device is installed under a slab in the dry cutting apparatus according to the embodiment of the present invention.

FIG. 13 is a view showing a first roller jig.

FIG. 14 is a view showing that a third roller jig is installed in FIG. 10.

FIG. 15 is a view showing the third roller jig.

FIG. 16 is a view showing that a wire is installed so as to rotate in a reverse direction in FIG. 14.

FIG. 17 is a view showing a safety cover member equipped with a wire guide tube.

FIG. 18 is a view separately showing the safety cover member and the wire guide tube.

FIG. 19 is a view showing that a slab is cut using a dry cutting apparatus according to another embodiment of the present invention.

FIG. 20 is an outer side view schematically showing a safety cover member and a wire guide tube.

FIG. 21 is a front view (a) and a left side view (b) showing a pulley moving device.

FIG. 22 is a view showing a dust collection port.

### BEST MODEL

The present invention may be variously changed and may have several embodiments, and therefore specific embodiments will be described in detail while being shown in the drawings. However, the present invention is not limited to the specific embodiments, and it should be understood that the present invention includes all alterations, equivalents, and substitutions falling within the idea and technical scope of the present invention.

The terms used in the present invention are used only to describe a specific embodiment, not to define the present invention. Singular forms include plural forms unless mentioned otherwise. It should be understood that the terms “comprises,” “has,” etc. specify the presence of stated features, numbers, steps, operations, elements, components, or combinations thereof described in this specification, but do not preclude the presence or addition of one or more other features, numbers, steps, operations, elements, components, or combinations thereof.

Hereinafter, preferred embodiments of the present invention will be described in detail with reference to the accompanying drawings. It should be noted that, in the accompanying drawings, the same elements are denoted by the same reference numerals wherever possible. In addition, a detailed description of known functions and configurations will be omitted when the same may obscure the subject matter of the present invention. In the accompanying drawings, some elements are exaggerated, omitted, or schematically shown for the same reason.

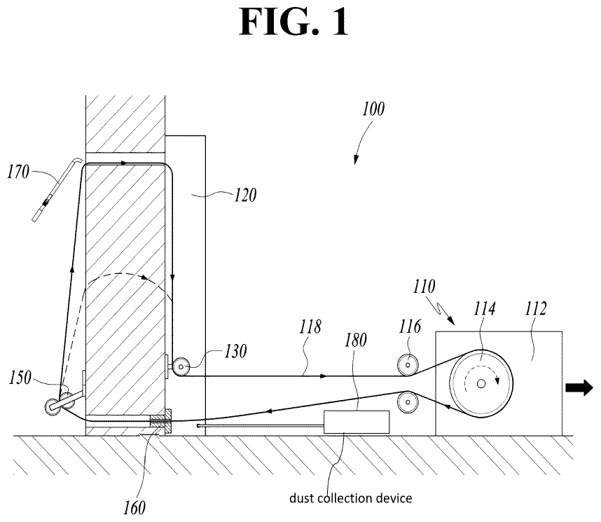

FIG. 1 is a view showing that a wall is cut using a dry cutting apparatus according to an embodiment of the present invention.

The dry cutting apparatus according to the present invention includes a wire saw device 110 configured to rotate a cutting wire installed so as to pass through two holes formed in a structure by drilling, a roller jig 130 mounted to one side of the structure to guide and support the cutting wire, a cover member 120 coupled to one side of the structure to cover and seal a cut region, an air gun 170 configured to blow compressed air to the cut region in a direction toward the cover member, and a dust collection device 180 connected to one side of the cover member via a dust collection hose to collect debris.

The wire saw device 110 of the present invention may cut a reinforced concrete structure by rotating a diamond wire saw. The structure cut by the wire saw device 110 may be a wall or a slab.

The wire saw device 110 may rotate the cutting wire 118 by rotating a drive pulley 114 mounted to one side of a main body 112 through a drive device provided in the main body 112. Although not shown in the figure, a plurality of wheels or a continuous track may be provided under the main body 112 such that the wire saw device 110 can be slowly reversed during a cutting operation.

A pair of guide rollers 116 may be mounted to the front of the main body 112 to tautly support and guide the wire 118 introduced into the drive pulley 114 and withdrawn from the drive pulley 114.

Two through-holes may be formed respectively in upper and lower parts of the wall by drilling, and the cutting wire 118 may pass through the two holes so as to surround the wall.

The roller jig 130 may be fixed directly above the lower hole of the wall to guide and support the cutting wire 118. The roller jig 130 may be installed at the point where the cutting wire 118 is bent by about 90 degrees to guide and support the wire 118 such that the wire can be smoothly rotated.

The cover member 120 may be coupled to one side of the wall facing the wire saw device 110 to cover and seal the cut region. The cover member 120 may be installed so as to cover the two holes formed in the wall and the wire part on one side of the wall, and the roller jig 130. If the lower hole is formed close to a floor surface, a lower surface of the cover member 120 may be fixed to the floor surface so as to be in tight contact therewith.

The air gun 170 may blow compressed air in a direction toward the cover member 120 as a worker moves along the cut region at the opposite side of the wall. In FIG. 1, the air gun 170 may blow the compressed air downward to the right. In the present invention, the cover member 120 is attached only to one side of the wall, but because the air gun 170 blows compressed air in the direction toward the cover member 120, most of the debris generated during cutting, such as dust, may be collected in the cover member 120.

The dust collection device 180 may collect debris collected in an inner space of the cover member 120 by suction. In the case of FIG. 1, since the inner space of the cover member 120 is elongated in a vertical direction, most of the debris is collected in a lower part of the inner space of the cover member 120 by gravity. Therefore, the dust collection hose connected to the dust collection device 180 is preferably connected to a lower part of one side of the cover member 120. Although the dust collection device 180 is shown as being disposed under the floor surface on which the wire saw device 110 is installed in the figure for convenience, in practice, the dust collection device 180 may be installed next to the wire saw device 110 on the floor surface on which the wire saw device 110 is installed.

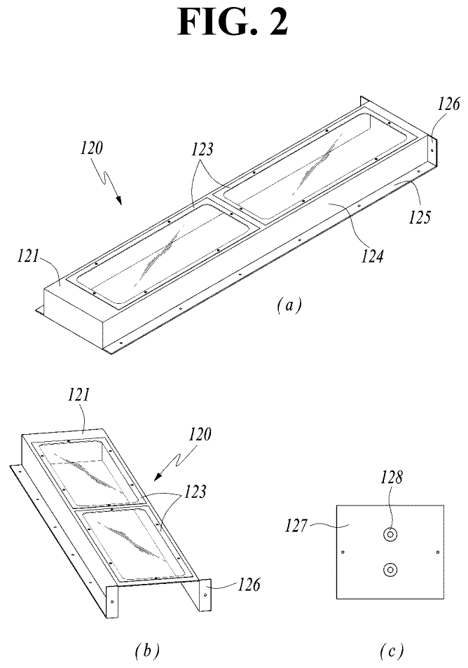

As shown in FIG. 2, the cover member 120 may include a main body plate portion 121 configured in the form of a rectangular plate, a transparent plate portion 123 coupled so as to cover an opening of the main body plate portion, a pair of sidewall portions 124 bent and extending from both sides of the main body plate portion, and a bottom flange portion 125 extending perpendicularly from the pair of sidewall portions so as to be fastened to the structure.

The cover member 120 may be formed by bending a metal plate. The main body plate portion 121 configured in the form of the rectangular plate may have at least one rectangular opening formed therein, and a plurality of fastening holes may be formed around the opening.

A transparent plate portion 123 may be formed larger than the opening, and a plurality of fastening holes is formed along the edge of the transparent plate portion such that the transparent plate portion can be fastened so as to cover the opening. The transparent plate portion 123 allows for visual inspection of the cut region and the condition of the wire during the cutting operation.

The pair of sidewall portions 124 may be bent and may extend downward from both sides of the main body plate portion 121. The pair of sidewall portions 124 may have sufficient height to cover the roller jig 130.

The bottom flange portion 125 may extend outward from lower ends of the pair of sidewall portions 124 and may be fixed to the structure by a plurality of anchor bolts.

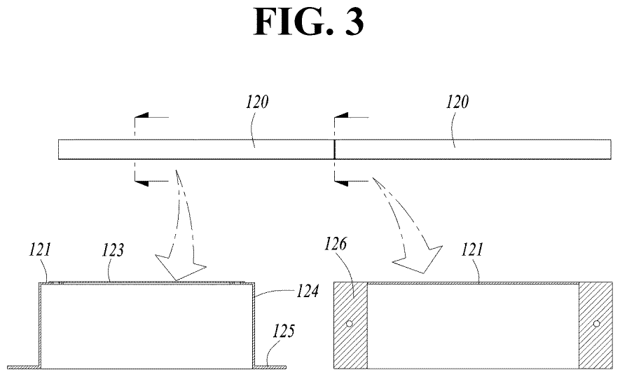

The cover member 120 may further include a pair of side flange portions 126 each bent outward from one end of a corresponding one of the pair of sidewall portions 124. A fastening hole may be formed in each of the side flange portions 126. As shown in FIG. 3, if it is necessary for the cover member 120 to be formed longer, two or more cover members 120 may be connected to each other by fastening bolts and nuts through the fastening holes in the state in which the side flange portions 126 of the two cover members 120 are in contact with each other.

In addition, the cover member 120 may further include a wire pass-through plate portion 127 having two through-holes through which the wire 118 passes. The wire pass-through plate portion 127 may be fastened to an upper surface of the main body plate 121 or may be fastened to the pair of side flange portions 126. The two through-holes may be formed larger than the wire 118, and a seal member 128 having an opening through which the wire 118 passes may be inserted into and mounted in each through-hole.

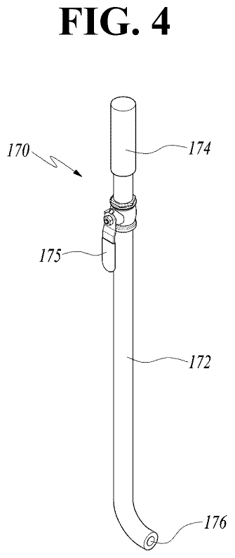

As shown in FIG. 4, the air gun 170 may include a main body portion 172 configured to allow compressed air to flow therein, a handle portion 174 provided on the main body portion, a valve 175 provided at the handle portion to control air blowing, and a blowing end portion 176 provided at an end of the main body portion such that an air blowing direction can be controlled.

The main body portion 172 is a metal tube connected from an air pump to an air hose. The handle portion 174 may be provided at one end of the main body portion 172 in a shape that is easy to grip. The valve 175, which controls the air flow rate, may be provided in the handle portion 174, and a lever configured to manipulate the valve 175 may protrude outward from the handle portion 174. The blowing end portion 176 may be provided at an end of the main body portion 172 so as to be bendable at a predetermined angle such that the air blowing direction can be controlled at a predetermined angle with respect to the main body portion 172.

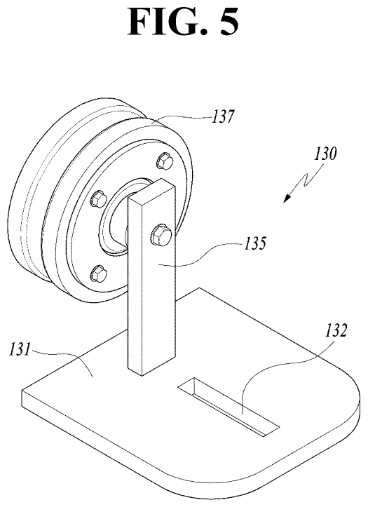

As shown in FIG. 5, the roller jig 130 may include a base portion 131 fastened to the structure, a support bracket 135 extending upward from the base portion, and a roller 137 mounted in at least one roller shaft hole formed in the support bracket to guide and support the cutting wire 118.

The roller jig 130 used in FIG. 1 may be a first roller jig 130 having one roller 137, as shown in FIG. 5.

The base portion 131 may be configured in the form of an approximately rectangular metal plate, and may have a long fastening hole 132 formed therein, whereby the base portion may be fastened and fixed to the structure by at least one anchor bolt.

The support bracket 135 may be coupled perpendicularly to the base portion 131 by welding. At least one roller shaft hole may be formed through the support bracket 135.

The roller 137 may have a shaft bearing provided in the center thereof, and may be mounted to a rotating shaft mounted in the roller shaft hole. The roller 137 may be made of a high-temperature special purpose plastic material, and may be provided in an outer circumferential surface thereof with a recess configured to allow a part of the wire 118 to be inserted thereinto.

As shown in FIG. 1, the dry cutting apparatus 100 for walls may further include a bar roller jig 150 installed on the side of the structure opposite the side on which the roller jig 130 is installed to guide and support the cutting wire 118.

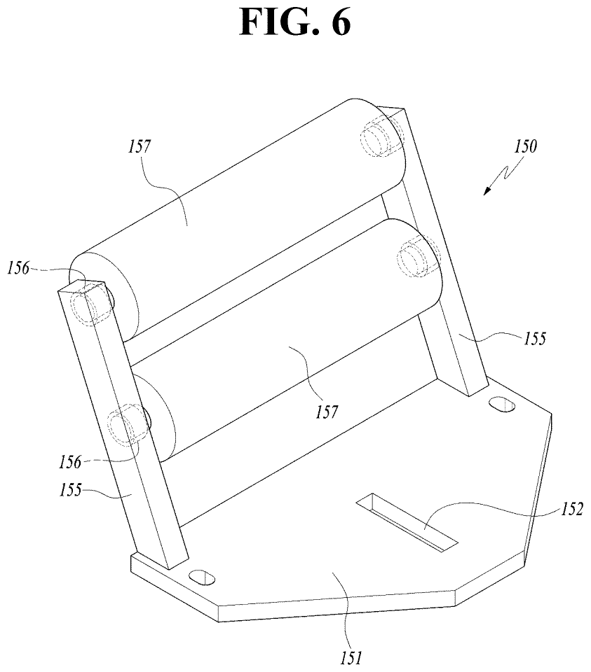

As shown in FIG. 6, the bar roller jig 150 may include a base portion 151 fastened to the structure, a pair of support brackets 155 extending upward from the base portion, and a bar roller 157 rotatably mounted between the pair of support brackets, the bar roller being formed in the shape of a long bar in an axial direction to guide and support the cutting wire 118.

The base portion 151 may be configured in the form of a hexagonal metal plate obtained as the result of two apexes of an approximate rectangle being chamfered. At least one long fastening hole 152 may be formed in the base portion 151 such that the base portion can be fixed to the structure by at least one anchor bolt.

The pair of support brackets 155 may be welded so as to be inclined upward from the base portion 151. Preferably, a roller shaft bearing 156 configured to rotatably support a roller shaft is mounted in each of the pair of support brackets 155.

The bar roller 157 may have a roller shaft formed in the center thereof, a high-heat special purpose plastic material may be provided around the roller shaft, and the bar roller may be formed in the shape of a long bar extending in the axial direction. Two bar rollers 157 may be mounted to the pair of support brackets 155 so as to be spaced apart from each other by a predetermined distance in order to support the cutting wire 118 passing therebetween. In the case of a general roller having a small axial length, the wire 118 may easily slip off the roller if the cutting wire 118 is loosened during cutting of the structure. In contrast, because the bar roller 157 is formed so as to have a long axial length, the wire 118 may be prevented from being dislodged from the long bar roller 157 even if the wire 118 is loosened.

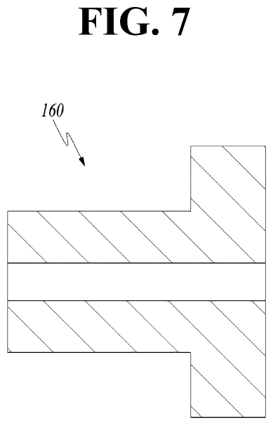

As shown in FIGS. 1 and 7, the dry cutting apparatus 100 may further include a packing member 160 having a through-hole configured to allow the cutting wire 118 to pass therethrough, the packing member being inserted into the hole formed in the structure by drilling to seal the hole.

Two holes are formed in the upper and lower parts of the wall by drilling, and the packing member 160 may be inserted into the hole formed in the lower part of the wall by drilling from the side with the wire saw device 110 to seal the hole. The packing member 160 may have a through-hole formed in the center thereof such that the cutting wire 118 passes through the through-hole, and may be configured to have a structure in which a head portion having a large area is formed at one end of a cylinder so as to form a step.

As shown in FIG. 1, the cutting wire 118 may be rotated in the direction in which the cutting wire passes through the packing member 160, may cut the upper part of the wall, and may be rotated toward the cover member 120. Consequently, most of the debris generated during cutting is moved into the inner space of the cover member 120 by the wire 118 that is rotating.

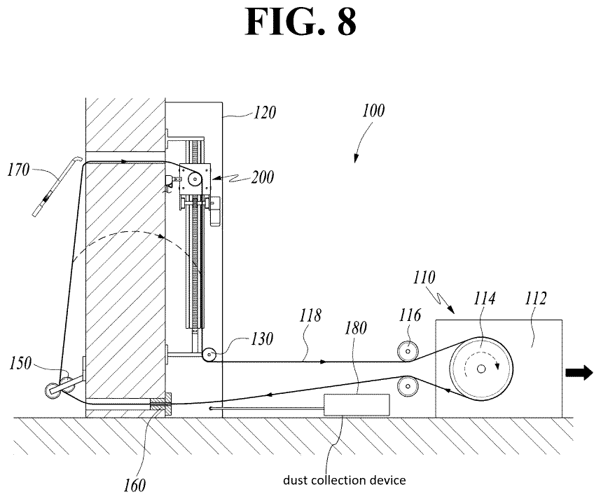

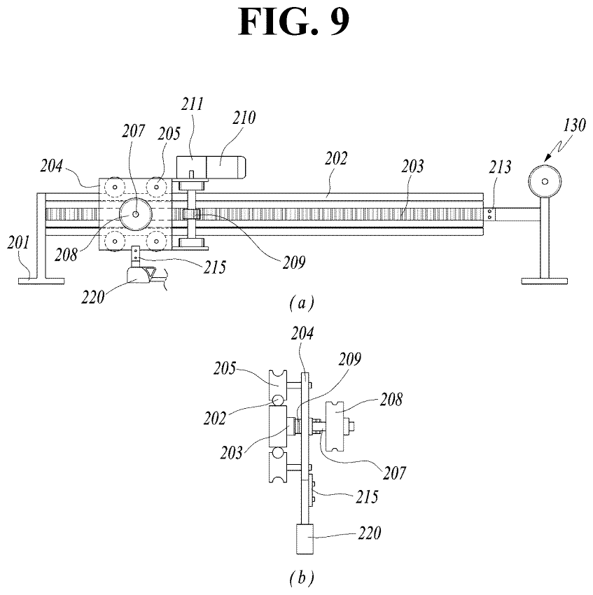

FIG. 8 is a view showing that a wall is cut using a dry cutting apparatus according to another embodiment of the present invention, and FIG. 9 is a front view (a) and a left side view (b) showing a pulley moving device. In (a) of FIG. 9, the pulley moving device is shown rotated 90 degrees in a counterclockwise direction for convenience.

In the present embodiment, the dry cutting apparatus further includes a pulley moving device 200 mounted between the wall and the roller jig 130 to move and support the cutting wire 118 during cutting.

The pulley moving device 200 may include a guide rail 202 fixed between the surface of the wall and the roller jig 130, a rack gear 203 formed on one side of the guide rail, a moving plate 204 slidably mounted to the guide rail, a pulley 208 rotatably mounted to the moving plate to support the cutting wire 118, a pinion gear 209 rotatably mounted to one side of the moving plate, the pinion gear being configured to engage with the rack gear, and a motor 210 configured to rotate the pinion gear.

The guide rail 202 may be configured in the form of a plate that is rectangular in shape. Each of an upper end and a lower end of the guide rail 202 may be formed so as to have an arc-shaped section. One side of the guide rail 202 may be coupled and fixed to a base portion 201 fastened to the surface of the wall by an anchor bolt. The other side of the guide rail 202 may be fastened to a coupling bracket 213 coupled to the support bracket 135 of the roller jig 130.

The rack gear 203 may be formed so as to extend in a longitudinal direction at the medium height on one side of the guide rail 202. The pinion gear 209 moves while rotating in a state of engaging with the rack gear 203.

The moving plate 204 may be configured in the form of a rectangular plate, and four support rollers 204 may be rotatably mounted to a rear side of the moving plate. Two pairs of support rollers 204 may be mounted respectively to an upper surface and a lower surface of the guide rail 202 so as to be rollable thereon such that the moving plate 204 can be supported on the guide rail 202 so as to be movable in the longitudinal direction in the state in which the orientation of the moving plate is maintained.

A pulley mounting shaft 207 may be fixed to a front side of the moving plate 204, and the pulley 208 may be rotatably mounted to the pulley mounting shaft 207. The wire 118 may be mounted on the pulley 208, and the pulley 208 may stably support the wire 118 while moving along the cut region during cutting.

The pinion gear 209 may be rotatably mounted to a pair of brackets fixed to one side of the moving plate 204. When the pinion gear 209 rotates, the moving plate 204 may move along the guide rail 202, whereby the pulley 208 may move in the longitudinal direction.

The pinion gear 209 may be rotated by an electric motor 210 and a reducer 211 mounted to the brackets of the moving plate 204. The electric motor 210 may forwardly and reversely rotate to move the moving plate 204 and the pulley 208 forward and rearward on the guide rail 202 under control performed outside the cover member 120.

The pulley moving device 200 may further include a dust collection port 220 coupled to a lower part of the moving plate 204 on the wall side to collect debris from the cut region. The dust collection port 220 may be removably coupled as a fixture 215 coupled thereto is fastened to the brackets provided on the lower part of the moving plate 204 by a plurality of bolts.

The dust collection port 220 may be configured in the form of a barrel having a recess through which the wire 118 passes, and may be installed so as to be in tight contact with the surface of the cut region of the wall. The dust collection hose may be connected to one side of the dust collection port 220, and the dust collection hose may extend outwardly of the cover member 120 so as to be connected to the dust collection device 180. Although the dust collection hose is also connected to a lower side of the cover member 120, the dust collection port 220 may directly suction debris generated during cutting from the cut region, whereby it is possible to efficiently reduce accumulation of debris in the cover member 120.

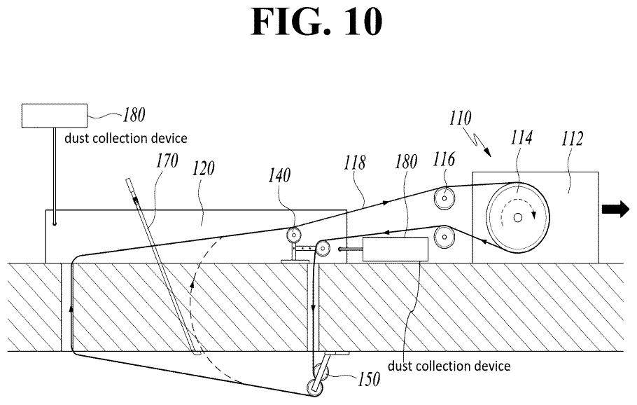

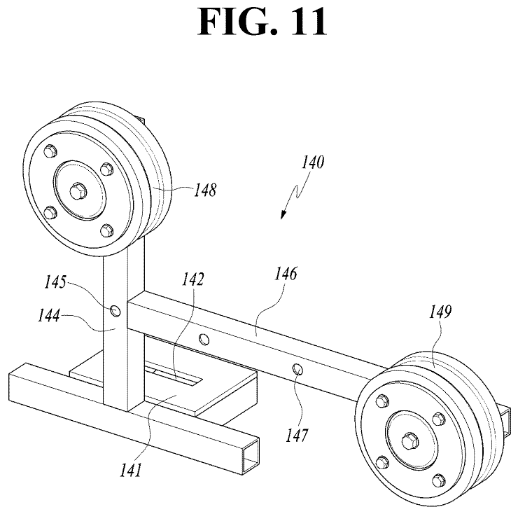

FIG. 10 is a view showing that a slab is cut using a dry cutting apparatus according to an embodiment of the present invention, and FIG. 11 is a view showing a second roller jig.

In the present embodiment, the dry cutting apparatus 100 cuts a slab by forming two holes in a slab structure by drilling and allowing a cutting wire 118 to pass through the holes.

A roller jig 140 may be fastened and fixed to an upper surface of a slab to be cut, and a cover member 120 may be coupled to the upper surface of the slab so as to cover and seal the two holes and the roller jig 140. The cover member 120 may have the same structure as described with reference to FIG. 2.

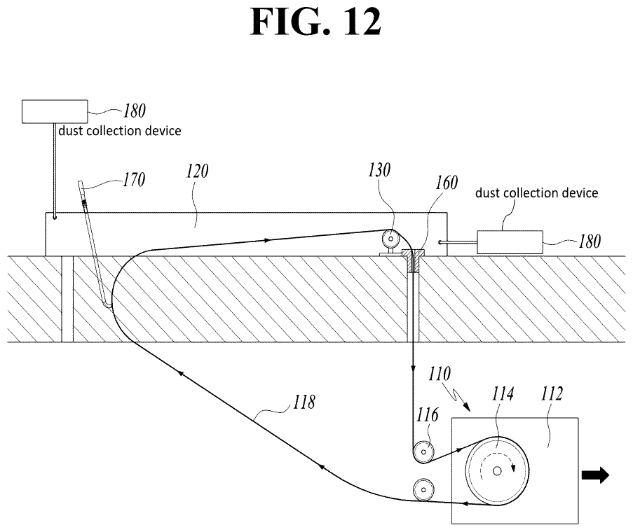

A wire saw device 110 may be installed on the upper surface of the slab outside the cover member 120. Dust collection devices 180 may be installed on the upper surface of the slab, and may be connected to one side and the other side of the cover member 120 via dust collection hoses. Specifically, as shown in FIG. 12, the dust collection hoses may be connected to an upper left part and a lower right part of the cover member 120 such that debris can be collected in the dust collection devices 180 installed on the upper surface of the slab. For convenience, two dust collection devices 180 are shown as being installed in FIG. 12, but in practice, two or more dust collection hoses may be connected to one dust collection device 180 on the right side.

As shown in FIG. 11, the roller jig 140 may include a base portion 141 fastened to the structure, a first support bracket 144 extending upward from the base portion, a second support bracket 146 extending from the middle of the first support bracket so as to be parallel to the base portion, a first roller 148 mounted in at least one roller shaft hole formed in the first support bracket, and a second roller 149 mounted in at least one roller shaft hole formed in the second support bracket.

The roller jig 140 used in FIG. 10 may be a second roller jig 140 having two rollers 148 and 149, as shown in FIG. 11.

The base portion 141 may be configured in the form of an approximately rectangular metal plate, and may have a long fastening hole 142 formed therein, whereby the base portion may be fastened and fixed to the upper surface of the slab by at least one anchor bolt.

The first support bracket 144 may be coupled perpendicularly to the base portion 141 by welding. The first support bracket 144 may be welded perpendicularly to an upper surface of a horizontal bar coupled to one side of the base portion 141. At least one first roller shaft hole 145 may be formed through the first support bracket 144.

The second support bracket 146 may be coupled to the side of the middle of the first support bracket 144 so as to extend parallel to the base portion 141 by welding. A plurality of second roller shaft holes 145 may be formed through the second support bracket 146.

The first roller 148 may have a shaft bearing provided in the center thereof, and may be mounted to a rotating shaft mounted in the first roller shaft hole 145. The first roller 148 may be made of a high-temperature special purpose plastic material, and may be provided in an outer circumferential surface thereof with a recess configured to allow a part of the wire 118 to be inserted thereinto.

The second roller 149 may have a shaft bearing provided in the center thereof, and may be mounted to a rotating shaft mounted in one of the plurality of second roller shaft holes 147. The second roller 149 may be made of a high-temperature special purpose plastic material, and may be provided in an outer circumferential surface thereof with a recess configured to allow a part of the wire 118 to be inserted thereinto. Since the plurality of second roller shaft holes 147 is formed, the second roller 149 may be mounted in any suitable one of the plurality of second roller shaft holes 147 depending on the position of the wire.

As shown in FIG. 10, the dry cutting apparatus 100 for walls may further include a bar roller jig 150 mounted to the side of the structure opposite the side to which the second roller jig 140 is mounted to guide and support the cutting wire 118.

As shown in FIG. 6, the bar roller jig 150 may include a base portion 151 fastened to the structure, a pair of support brackets 155 extending upward from the base portion, and a pair of bar rollers 157 rotatably mounted between the pair of support brackets, the bar roller being formed in the shape of a long bar in an axial direction to guide and support the cutting wire 118.

The base portion 151 may be configured in the form of a hexagonal metal plate obtained as the result of two apexes of an approximate rectangle being chamfered. At least one long fastening hole 152 may be formed in the base portion 151 such that the base portion can be fixed to the structure by at least one anchor bolt.

The pair of support brackets 155 may be welded so as to be inclined upward from the base portion 151. Preferably, a roller shaft bearing 156 configured to rotatably support a roller shaft is mounted in each of the pair of support brackets 155.

Each of the pair of bar rollers 157 may have a roller shaft formed in the center thereof, a high-heat special purpose plastic material may be provided around the roller shaft, and the bar roller may be formed in the shape of a long bar extending in the axial direction. In the case of a general roller having a small axial length, the wire 118 may easily slip off the roller if the cutting wire 118 is loosened during cutting of the structure. In contrast, because the bar roller 157 is formed so as to have a long axial length, the wire 118 may be prevented from being dislodged from between the long bar rollers 157 even if the wire 118 is loosened.

An air gun 170 may be the same as shown in FIG. 4. That is, the air gun 170 may include a main body portion 172 configured to allow compressed air to flow therein, a handle portion 174 provided on the main body portion, a valve 175 provided at the handle portion to control air blowing, and a blowing end portion 176 provided at an end of the main body portion such that an air blowing direction can be controlled.

The main body portion 172 is a metal tube connected from an air pump to an air hose. The handle portion 174 may be provided at one end of the main body portion 172 in a shape that is easy to grip. The valve 175, which controls the air flow rate, may be provided in the handle portion 174, and a lever configured to manipulate the valve 175 may protrude outward from the handle portion 174. The blowing end portion 176 may be provided at an end of the main body portion 172 so as to be bendable at a predetermined angle such that the air blowing direction can be controlled at a predetermined angle with respect to the main body portion 172.

Although not shown in FIG. 2, a plurality of air gun through-holes may be formed in a transparent plate portion 123 of the cover member 120. After the slab is cut a little, the air gun 170 may be inserted through one of the through-holes of the transparent plate portion 123 to blow compressed air upward, i.e. in a direction toward the cover member 120. The remainder of the plurality of air gun through-holes through which the air gun 170 has not been inserted may be sealed with rubber stoppers in order to prevent debris from escaping through the through-holes.

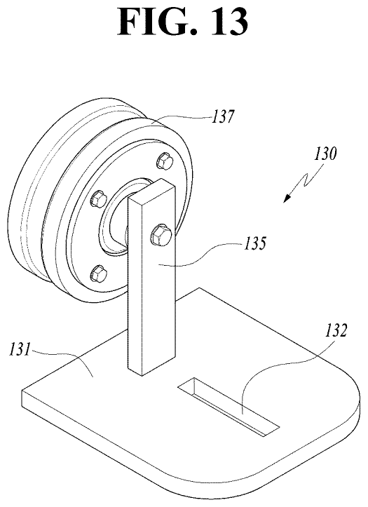

FIG. 12 is a view showing that a wire saw device is installed under a slab in the dry cutting apparatus according to the embodiment of the present invention, and FIG. 13 is a view showing a first roller jig.

In the dry cutting apparatus shown in FIG. 12, the wire saw device 110 is installed under a slab to be cut, rather than on an upper surface of the slab. It may be difficult to install the wire saw device 110 on an upper surface of a slab to be cut depending on the on-site situation, in which case the wire saw device 110 may be installed under the slab.

That is, in the dry cutting apparatus shown in FIG. 12, a structure to be cut may be a slab, the cover member 120 may be coupled to an upper surface of the slab, and the wire saw device 110 may be installed under the slab. Dust collection devices 180 may be installed on the upper surface of the slab to be cut, and the dust collection devices 180 may be connected to one side and the other side of the cover member 120 via dust collection hoses.

A roller jig used in the present embodiment may be a first roller jig 130 having one roller. That is, as shown in FIG. 13, the first roller jig 130 may include a base portion 131 fastened to the upper surface of the slab, the base portion having a long fastening hole 132, a support bracket 135 extending upward from the base portion, and a roller 137 mounted in at least one roller shaft hole formed in the support bracket to guide and support a cutting wire 118.

An air gun 170 may be the same as shown in FIG. 4. That is, the air gun 170 may include a main body portion 172 configured to allow compressed air to flow therein, a handle portion 174 provided on the main body portion, a valve 175 provided at the handle portion to control air blowing, and a blowing end portion 176 provided at an end of the main body portion such that an air blowing direction can be controlled.

The main body portion 172 is a metal tube connected from an air pump to an air hose. The handle portion 174 may be provided at one end of the main body portion 172 in a shape that is easy to grip. The valve 175, which controls the air flow rate, may be provided in the handle portion 174, and a lever configured to manipulate the valve 175 may protrude outward from the handle portion 174. The blowing end portion 176 may be provided at an end of the main body portion 172 so as to be bendable at a predetermined angle such that the air blowing direction can be controlled at a predetermined angle with respect to the main body portion 172.

The air gun 170 may be inserted through the cover member 120 to blow compressed air in order to move debris generated during cutting toward the cover member 120.

In FIG. 12, a packing member 160 may be inserted into a hole formed in the right side of the slab by drilling to seal the hole. The packing member 160 may be inserted into the right hole from the upper surface side of the slab, and the cutting wire 118 may be rotated so as to pass through a through-hole formed in the center of the packing member 160 from top to bottom. As a result, the packing member 160 may prevent debris collected in an inner space of the cover member 120 from escaping through the right hole.

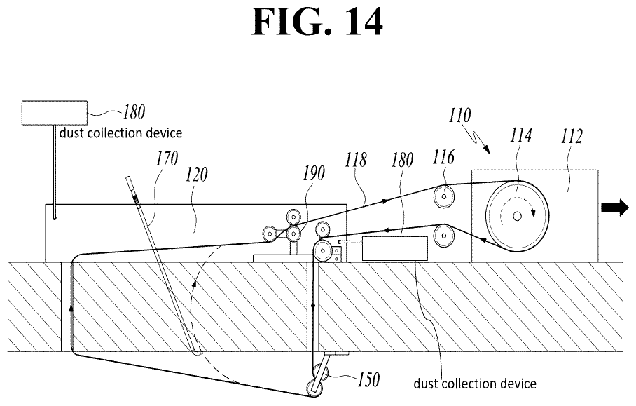

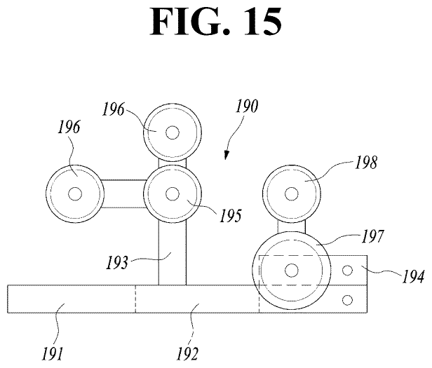

FIG. 14 is a view showing that a third roller jig is installed in FIG. 10, and FIG. 15 is a view showing the third roller jig.

The dry cutting apparatus shown in FIG. 14 is identical in other configurations to the dry cutting apparatus shown in FIG. 10 except that a third roller jig 190 is installed in place of the second roller jig 140.

In the dry cutting apparatus according to the present embodiment, the wire saw device 110 may be installed on the upper surface of the slab in order to cut the slab, and the cover member 120 and the dust collection devices 180 may also be installed on the upper surface of the slab.

A roller jig used in the present embodiment may be a third roller jig 190 having a plurality of rollers. That is, the third roller jig 190 may include a base portion 191 fastened to the upper surface of the slab, a “┐”-shaped first support bracket 193 extending upward from the base portion, a “└”-shaped second support bracket 194 extending upward from an upper surface of the base portion, a first roller 195 and an auxiliary roller 196 mounted in a plurality of roller shaft holes formed in the first support bracket so as to be spaced apart from each other by a predetermined distance, and a second roller 197 and an anti-slip roller 198 mounted in a plurality of roller shaft holes formed in the base portion and the second support bracket.

The base portion 191 may be configured in the form of an approximately rectangular metal plate, and may have a long fastening hole 192 formed therein, whereby the base portion may be fastened and fixed to the upper surface of the slab by at least one anchor bolt.

The first support bracket 193 may be coupled perpendicularly to the base portion 191 by welding. The first support bracket 144 may be welded perpendicularly to an upper surface of a horizontal bar coupled to one side of the base portion 191. The first support bracket 193 may be formed in a “┐” shape when viewed from the front, as shown in FIG. 15. A plurality of first roller shaft holes may be formed through the first support bracket 193 such that the first roller 195 can be selectively mounted in one of the plurality of first roller shaft holes.

The second support bracket 194 may be coupled to an upper surface of the base portion 191 by welding so as to be located thereon. The second support bracket 194 may be formed in a “└” shape when viewed from the front, as shown in FIG. 15. A plurality of second roller shaft holes may be formed through the second support bracket 194 such that the second roller 197 can be mounted in one of the plurality of second roller shaft holes. In addition, a plurality of second roller shaft holes may also be formed through the base portion 191 to which the second support bracket 194 is coupled. Consequently, the second roller 197 may be selectively mounted in any one of the second roller shaft holes formed in the second support bracket 194 and the base portion 191.

The first roller 195 may have a shaft bearing provided in the center thereof, and may be mounted to a rotating shaft mounted in the first roller shaft hole. The first roller 195 may be made of a high-temperature special purpose plastic material, and may be provided in an outer circumferential surface thereof with a recess configured to allow a part of the wire 118 to be inserted thereinto.

The auxiliary roller 196 may be mounted to the left side of the first support bracket 193 so as to be located at the same height as the first roller 195, and another auxiliary roller 196 may be mounted to the first support bracket 193 so as to be located above the first roller 195. The auxiliary roller 196 may guide and support the cutting wire 180 such that the cutting wire can be smoothly rotated, and may prevent the wire 180 from easily slipping off the first roller 195.

The second roller 197 may have a shaft bearing provided in the center thereof, and may be mounted to a rotating shaft mounted in one of the plurality of second roller shaft holes. The second roller 197 may be made of a high-temperature special purpose plastic material, and may be provided in an outer circumferential surface thereof with a recess configured to allow a part of the wire 118 to be inserted thereinto. Since the plurality of second roller shaft holes is formed, the second roller 149 may be mounted in any suitable one of the plurality of second roller shaft holes depending on the position of the wire.

The anti-slip roller 198 may be mounted to an upper end of the second support bracket 194. The anti-slip roller 198 may also be provided in an outer circumferential surface thereof with a guide recess configured to guide the wire 118. The anti-slip roller 198 may prevent the wire 118 from slipping off the second roller 197 while passing over the second roller.

The air gun 170 may be inserted through the cover member 120 to blow compressed air in order to move debris generated during cutting toward the cover member 120.

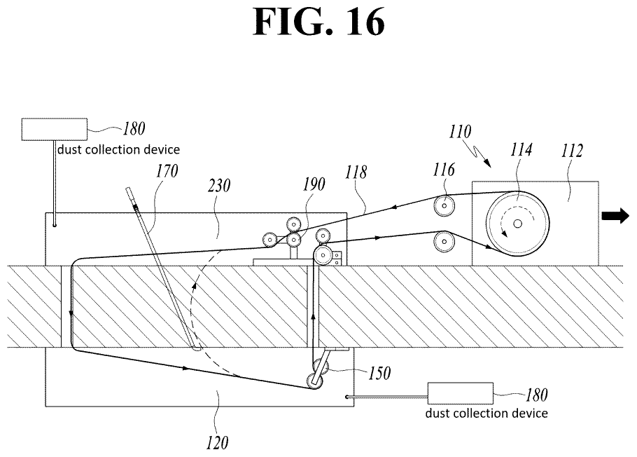

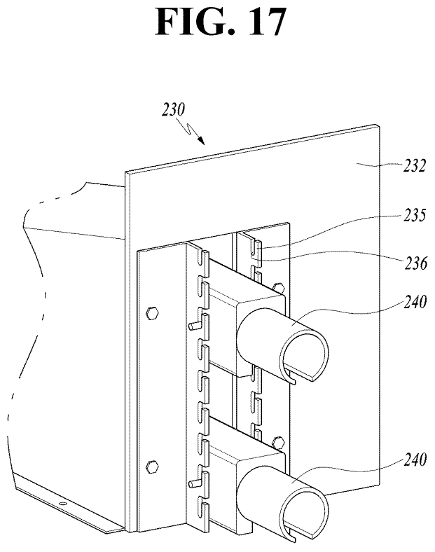

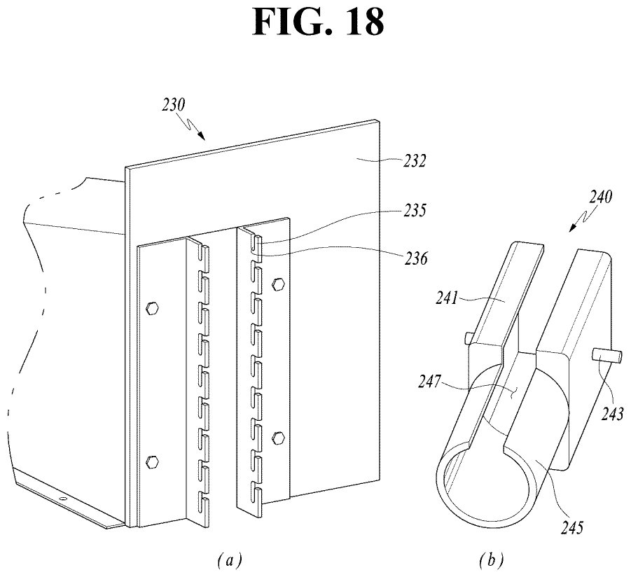

FIG. 16 is a view showing that the wire is installed so as to rotate in a reverse direction in FIG. 14, FIG. 17 is a view showing a safety cover member equipped with a wire guide tube, and FIG. 18 is a view separately showing the safety cover member and the wire guide tube.

In the embodiment shown in FIG. 16, when the wire 118 is rotated in the reverse direction, the cover member 120 may be coupled to the lower surface of the slab because debris generated during cutting mainly falls downward. In this case, it is preferable for a safety cover member 230 to be mounted to the upper surface of the slab such that the rotating wire 118 and the third roller jig 190 are not exposed. In addition, the dust collection device 180 may be disposed under the slab in the state in which a dust collection hose connects the cover member 120 to the dust collection device 180.

As shown in FIG. 17, the safety cover member 230 is similar to the cover member 120 in that the safety cover member includes a main body plate portion, a transparent plate portion, a sidewall portion, and a flange portion. However, the safety cover member 230 is different from the cover member 120 in that a wire pass-through plate 232 is coupled to one side of the safety cover member 230 where the wire 118 enters and exits.

As shown in (a) of FIG. 18, the wire pass-through plate 232 may be configured in the form of a rectangular metal plate having a sectional area greater than the sectional area of the safety cover member 230. A long through-hole extending in a vertical direction may be formed in the wire pass-through plate 232, and a pair of guide tube mounting ribs 235 may be coupled to the left and right sides of the through-hole.

Each of the pair of guide tube mounting ribs 235 may be provided with a plurality of “-”-shaped mounting recesses 236, whereby two wire guide tubes 240 may be mounted at appropriate heights.

As shown in (b) of FIG. 18, the wire guide tube 240 may be formed by coupling a quadrangular tube portion 241 made of metal and a circular tube portion 245 made of metal to each other by welding. A pair of mounting shafts 243 may be coupled respectively to opposite sides of the quadrangular tube portion 241 by welding. The wire guide tube 240 may be mounted at a desired height by inserting the pair of mounting shafts 243 into the mounting recesses 236 of the pair of guide tube mounting ribs 235.

An incision portion 247 cut in a longitudinal direction may be formed at one side of the wire guide tube 240 in a radial direction. Since the incision portion 247 is formed in the wire guide tube 240, the wire 118 may be easily inserted into the wire guide tube 240 through the incision portion 247.

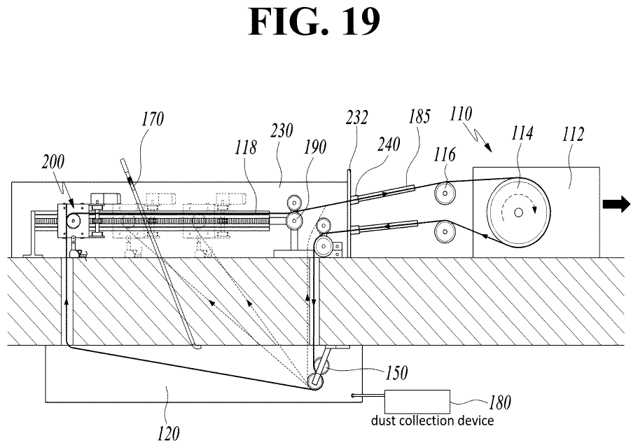

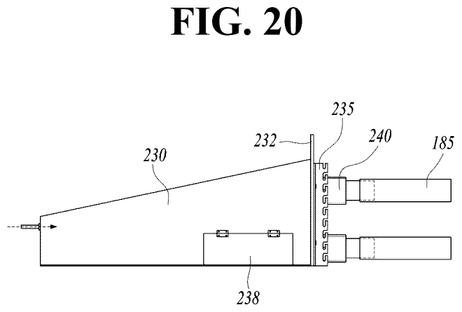

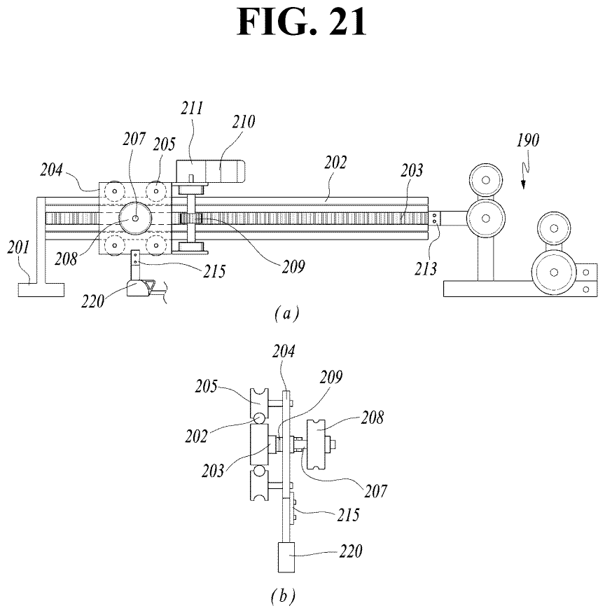

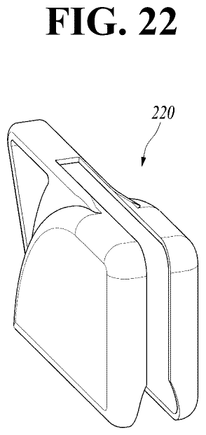

FIG. 19 is a view showing that a slab is cut using a dry cutting apparatus according to another embodiment of the present invention, FIG. 20 is an outer side view schematically showing a safety cover member and a wire guide tube, FIG. 21 is a front view (a) and a left side view (b) showing a pulley moving device, and FIG. 22 is a view showing a dust collection port.

In the dry cutting apparatus according to the present embodiment, a cover member is coupled to each of an upper surface and a lower surface of the slab, and a wire saw device 110 is installed on the upper surface of the slab outside the cover member. In addition, a dust collection device 180 is installed under the slab, a third roller jig 190 is used as a roller jig, and a pulley moving device 200 is installed between the upper surface of the slab and the third roller jig 190.

As shown in FIG. 19, a cover member 120 may be coupled to the lower surface of the slab, and a safety cover member 230 may be coupled to the upper surface of the slab. In this case, the cover member 120 may receive a bar roller jig 120 and a wire 118, and the safety cover member 230 may receive the third roller jig 190 and the pulley moving device 200.

As shown in FIG. 20, a wire pass-through plate 232 may be provided at one side of the safety cover member 230, and a pair of wire guide tubes 240 may be mounted to guide tube mounting ribs 235 coupled to the wire pass-through plate 232. A wire connection tube 185 extending to the wire saw device 110 may be coupled to each of the pair of wire guide tubes 240.

At least one blowing hole configured to allow compressed air to be blown to a cut region therethrough may be formed at the other side of the safety cover member 230. An air gun 170 may be inserted through the blowing hole to blow compressed air directly in front of the cut region.

In addition, a hinged door 238 may be mounted to one side of the safety cover member 230. Although the door 238 is shown as being mounted to an approximate lower right part of the safety cover member 230, a plurality of doors may also be mounted to an upper right part and a left half of the safety cover member 230. After the safety cover member 230 is installed, the door 238 may be opened to facilitate operations such as hooking the wire 118 onto the roller jig or pulling the wire out.

As shown in FIG. 21, the third roller jig 190 may be provided with a coupling bracket 213 configured to couple one side of the pulley moving device 200 instead of the auxiliary roller 196 provided at the left side of the first roller 195 in the configuration described above.

The pulley moving device 200 may include a guide rail 202 fixed between the surface of the slab and the third roller jig 190, a rack gear 203 formed on one side of the guide rail, a moving plate 204 slidably mounted to the guide rail, a pulley 208 rotatably mounted to the moving plate to support the cutting wire 118, a pinion gear 209 rotatably mounted to one side of the moving plate, the pinion gear being configured to engage with the rack gear, and a motor 210 configured to rotate the pinion gear.

The guide rail 202 may be configured in the form of a plate that is rectangular in shape. Each of an upper end and a lower end of the guide rail 202 may be formed so as to have an arc-shaped section. One side of the guide rail 202 may be coupled and fixed to a base portion 201 fastened to the surface of the wall by an anchor bolt. The other side of the guide rail 202 may be fastened to a coupling bracket 213 coupled to the support bracket 135 of the roller jig 130.

The rack gear 203 may be formed so as to extend in a longitudinal direction at the medium height on one side of the guide rail 202. The pinion gear 209 moves while rotating in a state of being engaged with the rack gear 203.

The moving plate 204 may be configured in the form of a rectangular plate, and four support rollers 204 may be rotatably mounted to a rear side of the moving plate. Two pairs of support rollers 204 may be mounted respectively to an upper surface and a lower surface of the guide rail 202 so as to be rollable thereon such that the moving plate 204 can be supported on the guide rail 202 so as to be movable in the longitudinal direction in the state in which the posture of the moving plate is maintained.

A pulley mounting shaft 207 may be fixed to a front side of the moving plate 204, and the pulley 208 may be rotatably mounted to the pulley mounting shaft 207. The wire 118 may be mounted on the pulley 208, and the pulley 208 may stably support the wire 118 while moving along the cut region during cutting.

The pinion gear 209 may be rotatably mounted to a pair of brackets fixed to one side of the moving plate 204. When the pinion gear 209 rotates, the moving plate 204 may move along the guide rail 202, whereby the pulley 208 may move in the longitudinal direction.

The pinion gear 209 may be rotated by an electric motor 210 and a reducer 211 mounted to the brackets of the moving plate 204. The electric motor 210 may forwardly and reversely rotate to move the moving plate 204 and the pulley 208 forward and rearward on the guide rail 202 under control performed outside the cover member 120.

The pulley moving device 200 may further include a dust collection port 220 coupled to a lower part of the moving plate 204 on the wall side to collect debris from the cut region. The dust collection port 220 may be removably coupled as a fixture 215 coupled thereto is fastened to the brackets provided on the lower part of the moving plate 204 by a plurality of bolts.

As shown in FIGS. 21 and 22, the dust collection port 220 may be configured in the form of a barrel having a recess through which the wire 118 passes, and may be installed so as to be in tight contact with the surface of the cut region of the wall. A dust collection hose may be connected to one side of the dust collection port 220, and the dust collection hose may extend outwardly of the cover member 120 so as to be connected to the dust collection device 180. Although the dust collection hose is also connected to a lower side of the cover member 120, the dust collection port 220 may directly suction debris generated during cutting from the cut region, whereby it is possible to efficiently reduce accumulation of debris in the cover member 120.

The dry cutting apparatus according to the present embodiment includes the pulley moving device 200, whereby it is possible to support the wire 118 passing through the cut region of the slab while maintaining an approximately straight shape when the wire 118 moves while performing the cutting operation.

In the absence of the pulley moving device 200, the wire 118 passing through the cut region of the slab is rotated while being pulled in a curved form having a small radius of curvature. In contrast, in the present embodiment, the pulley moving device 200 may cause the wire 118 passing through the cut region of the slab to have a very large radius of curvature or to maintain a straight shape. Accordingly, the length of the wire 118 in contact with the cut surface of the slab is relatively small, whereby less heat is generated from the wire 118, which may extend the lifespan of the wire. In addition, a straight wire is easier to rotate and easier to spin than a curved wire, which may extend the lifespan of the wire and increase the cutting force.

In the dry cutting apparatus according to the present invention, it is possible to easily cut a structure, such as a wall or a slab, by installing a cover member only at one side of the structure, blowing compressed air toward a cover member using an air gun, and operating a wire saw device, and to collect debris generated during cutting using a dust collection device.

Although an embodiment of the present invention has been described above, it will be apparent to a person having ordinary skill in the art to which the present invention pertains that the present invention can be variously modified and altered through addition, change, deletion, or supplement of components without departing from the idea of the present invention recited in the following claims and that such modifications and alterations fall within the scope of right of the present invention.

### DESCRIPTION OF REFERENCE NUMERALS

100: Dry cutting apparatus 110: Wire saw device 112: Main body 114: Drive pulley
116: Guide roller 118: Wire 120: Cover member 121: Main body plate portion
123: Transparent plate portion 124: Sidewall portion 125: Bottom flange portion 126: Side flange portion
127: Wire pass-through plate portion 128: Seal member 130: First roller jig 131: Base portion
132: Fastening hole 135: Support bracket 137: Roller 140: Second roller jig
141: Base portion 142: Fastening hole 144: First support bracket 145: First roller shaft hole
146: Second support bracket 147: Second roller shaft hole 148: First roller 149: Second roller
150: Bar roller jig 151: Base portion 152: Fastening hole 155: Support bracket
156: Roller shaft bearing 157: Bar roller 160: Packing member 170: Air gun
172: Main body portion 174: Handle portion 175: Valve 176: Blowing end portion 180: Dust collection device
185: Wire connection tube 190: Third roller jig 191: Base portion 192: Fastening hole 193: First support bracket 194: Second support bracket 195: First roller 196: Auxiliary roller 197: Second roller 198: Anti-slip roller 200: Pulley moving device 201: Base portion
202: Guide rail 203: Rack gear 204: Moving plate 205: Support roller
207: Pulley mounting shaft 208: Pulley 209: Pinion gear 210: Motor 211: Reducer
213: Coupling bracket 215: Fixture 220: Dust collection port 230: Safety cover member
232: Wire pass-through plate 235: Guide tube mounting rib 236: Mounting recess 238: Door
240: Wire guide tube 241: Quadrangular tube portion 243: Mounting shaft 245: Circular tube portion
247: Incision portion

### INDUSTRIAL APPLICABILITY

A dry cutting apparatus and cutting method for walls or slabs according to the present invention is applicable to the industry of dismantling structures.

1. A dry cutting apparatus comprising:
a wire saw device configured to rotate a cutting wire installed so as to pass through two holes formed in a structure by drilling;
a roller jig mounted to one side of the structure, the roller jig being configured to guide and support the cutting wire;
a cover member coupled to one side of the structure, the cover member being configured to cover and seal a cut region;
an air gun configured to blow compressed air to the cut region in a direction toward the cover member; and
a dust collection device connected to one side of the cover member via a dust collection hose, the dust collection device being configured to collect debris.

2. The dry cutting apparatus according to claim 1, wherein the cover member comprises:
a main body plate portion configured in a form of a rectangular plate;
a transparent plate portion coupled so as to cover an opening of the main body plate portion;
a pair of sidewall portions bent and extending from both sides of the main body plate portion; and
a bottom flange portion extending perpendicularly from the pair of sidewall portions so as to be fastened to the structure.

3. The dry cutting apparatus according to claim 2, wherein the cover member comprises a pair of side flange portions each bent Outward from one end of a corresponding one of the pair of sidewall portions.

4. The dry cutting apparatus according to claim 1, wherein the air gun comprises:
a main body portion configured to allow compressed air to flow therein;
a handle portion provided on the main body portion;
a valve provided at the handle portion, the valve being configured to control air blowing; and
a blowing end portion provided at an end of the main body portion such that an air blowing direction can be controlled.

5. The dry cutting apparatus according to claim 1, wherein the roller jig comprises:
a base portion fastened to the structure;
a support bracket extending upward from the base portion; and
a roller mounted in at least one roller shaft hole formed in the support bracket, the roller being configured to guide and support the cutting wire.

6. The dry cutting apparatus according to claim 1, further comprising a bar roller jig installed on a side of the structure opposite a side on which the roller jig is installed, the bar roller jig being configured to guide and support the cutting wire.

7. The dry cutting apparatus according to claim 6, wherein the bar roller jig comprises:
a base portion fastened to the structure;
a pair of support brackets extending upward from the base portion; and
a bar roller rotatably mounted between the pair of support brackets, the bar roller being formed in a shape of a long bar in an axial direction, the bar roller being configured to guide and support the cutting wire.

8. The dry cutting apparatus according to claim 1, further comprising a packing member having a through-hole configured to allow the cutting wire to pass therethrough, the packing member being inserted into the hole formed in the structure by drilling, the packing member being configured to seal the hole.

9. The dry cutting apparatus according to claim 1, further comprising a pulley moving device having one side coupled to an upper surface of a slab and the other side coupled to a roller jig, the pulley moving device being configured to move a pulley configured to support the cutting wire along the cut region.

10. The dry cutting apparatus according to claim 1, wherein
the structure to be cut is a slab,
the cover member is coupled to an upper surface of the slab,
the wire saw device is installed on the upper surface of the slab outside the cover member, and
the roller jig comprises:
a base portion fastened to the structure;
a first support bracket extending upward from the base portion;
a second support bracket extending from a middle of the first support bracket so as to be parallel to the base portion;
a first roller mounted in at least one roller shaft hole formed in the first support bracket; and
a second roller mounted in at least one roller shaft hole formed in the second support bracket.

11. The dry cutting apparatus according to claim 1, wherein
the structure to be cut is a slab,
the cover member is coupled to an upper surface of the slab,
the wire saw device is installed under the slab, and
the roller jig comprises:
a base portion fastened to the structure;
a support bracket extending upward from the base portion; and
a roller mounted in at least one roller shaft hole formed in the support bracket, the roller being configured to guide and support the cutting wire.

12. The dry cutting apparatus according to claim 1, wherein
the structure to be cut is a slab,
the cover member is coupled to an upper surface of the slab,
the wire saw device is installed on the upper surface of the slab outside the cover member, and
the roller jig comprises:
a base portion fastened to the structure;
a “┐”-shaped first support bracket extending upward from the base portion;
a “└”-shaped second support bracket extending upward from an upper surface of the base portion;
a first roller and an auxiliary roller mounted in a plurality of roller shaft holes formed in the first support bracket so as to be spaced apart from each other by a predetermined distance; and
a second roller and an anti-slip roller mounted in a plurality of roller shaft holes formed in the base portion and the second support bracket.

13. The dry cutting apparatus according to claim 1, wherein
the structure to be cut is a slab,
the cover member is coupled to each of an upper surface and a lower surface of the slab,
the wire saw device is installed on the upper surface of the slab outside the cover member,
the dust collection device is installed under the slab,
the roller jig comprises:
a base portion fastened to the structure;
a “┐”-shaped first support bracket extending upward from the base portion;
a “└”-shaped second support bracket extending upward from an upper surface of the base portion;
a first roller and an auxiliary roller mounted in a plurality of roller shaft holes formed in the first support bracket so as to be spaced apart from each other by a predetermined distance; and
a second roller and an anti-slip roller mounted in a plurality of roller shaft holes formed in the base portion and the second support bracket, and
the dry cutting apparatus further comprises a pulley moving device having one side coupled to the upper surface of the slab and the other side coupled to the roller jig, the pulley moving device being configured to move a pulley configured to support the cutting wire along the cut region.

14. The dry cutting apparatus according to claim 13, wherein the pulley moving device comprises:
a guide rail fixed between the upper surface of the slab and the roller jig;
a rack gear formed on one side of the guide rail;
a moving plate slidably mounted to the guide rail;
a pulley rotatably mounted to the moving plate, the pulley being configured to support the cutting wire;
a pinion gear rotatably mounted to one side of the moving plate, the pinion gear being configured to engage with the rack gear; and
a motor configured to rotate the pinion gear.

15. The dry cutting apparatus according to claim 14, wherein the pulley moving device further comprises a dust collection port coupled to the moving plate, the dust collection port being configured to collect debris from the cut region.
